(19) United States
(12) Patent Application Publication
(10) Pub. No.: US 2026/0237887 A1
(43) Pub. Date: Aug. 13, 2026

(54) ANTENNA ASSEMBLY AND BASE STATION ANTENNA

(71) Applicant: Outdoor Wireless Networks LLC, Richardson, TX (US)

(72) Inventors: Jian Liu, Suzhou (CN); YueMin Li, Suzhou (CN); HongHui Chen, Suzhou (CN); Long Shan, Suzhou (CN)

(21) Appl. No.: 19/533,490

(22) Filed: Feb. 9, 2026

(30) Foreign Application Priority Data
Feb. 11, 2025 (CN) 2025101498563

(51) Int. Cl. H01Q 1/24; H01Q 3/36; H01Q 9/16; H01Q 15/24; H01Q 19/10

(52) U.S. Cl. CPC H01Q 1/246; H01Q 3/36; H01Q 9/16; H01Q 15/24; H01Q 19/104

(57) ABSTRACT

The present invention relates to an antenna assembly comprising: a plurality of dual-polarization radiating elements, each dual-polarization radiating element comprising a dipole radiator pair and a feed stalk for mounting the dipole radiator pair, wherein each dual-polarization radiating element is operable within a first operating frequency band, a feeder panel for feeding each dual-polarization radiating element, the feeder panel including a power divider, wherein the respective feed stalks and the feeder panel form an integrated feed printed circuit board. Additionally, the present invention relates to a base station antenna.

### CROSS-REFERENCE TO RELATED APPLICATION

The present application claims priority to Chinese Patent Application No. 202510149856.3, filed Feb. 11, 2025, the entire content of which is incorporated herein by reference as if set forth fully herein.

### FIELD

The present disclosure relates to a communication system, and more particularly relates to an antenna assembly and a base station antenna suitable for the communication system.

### BACKGROUND

Cellular communication systems are well known in this field. In a typical cellular communication system, a geographic area is divided into a series of regions that are referred to as “cells”, and each cell is served by a base station. The base station may comprise baseband equipment, a radio transceiver device, and a base station antenna, which is configured to provide two-way radio frequency (“RF”) communication for subscribers positioned throughout the cell. In many cases, the cell may be divided into a plurality of “sectors” in the azimuth plane, and separate base station antennas provide coverage for each sector. Base station antennas are often mounted on towers or other raised structures, and radiation patterns generated by each antenna (“antenna beams”) are directed outwardly from the antennas to service respective sectors. Usually, the base station antenna comprises one or more phased arrays of radiating elements, and when the antenna is installed and used, the radiating elements are arranged in one or more vertical columns. “Vertical” herein refers to a direction perpendicular to a plane defined by a horizon.

A common base station configuration is a “three-sector” configuration, wherein the cell is divided into three 120° sectors in the azimuth plane, and the base station can comprise at least three base station antennas that provide coverage for the three respective sectors. The azimuth plane refers to a horizontal plane that bisects the base station antenna and is parallel to the plane defined by the horizon. In a three-sector configuration, antenna beams generated by each base station antenna typically have a half-power beam width (“HPBW”) of approximately 65° in the azimuth plane, such that the antenna beams provide good coverage within each 120° sector. Typically, each base station antenna comprises a linear array of radiating elements that extend vertically, and these radiating elements together generate the antenna beams. Each radiating element may have an HPBW of approximately 65°, such that the antenna beams generated by the linear array of the radiating elements will cover the 120° sectors in the azimuth plane. These linear arrays may comprise a linear array of “low-band” radiating elements to provide service for some or all of the 617–960 MHz frequency bands, and/or a linear array of “mid-band” radiating elements to provide service for some or all of the 1,427–2,690 MHz frequency bands, and/or a multi-column array of “high-band” radiating elements to provide service for some or all of the 3–5 GHz frequency bands.

The radiating elements of above-described linear arrays are generally configured as dual-polarization radiating elements, which allows each linear array to send and receive RF signals in two orthogonal polarizations (i.e., each polarization produces an antenna beam). The dual-polarization radiating element is typically implemented as a -/+45⁰ radiating element having a first radiator that sends and receives -45⁰ polarized RF radiation and a second radiator that sends and receives +45⁰ polarized RF radiation. Each linear array may be connected to two RF ports (one RF port for each polarization) of the antenna and each RF port may be connected to a corresponding port of a radio device (radio) in order to receive RF signals from the radio device.

The RF signals of the first polarization (e.g., +45⁰ polarized) received from the radio device may be divided into a plurality of sub-components, each sub-component being fed to a first polarization radiator of a respective subset of radiating elements in a linear array, each subset of radiating elements may typically include one, two, three, or more radiating elements. The sub-components of the RF signals may be transmitted by the first polarization radiators of a respective radiating element to generate a first polarized antenna beam. Typically, these linear arrays have a remote electronic tilt (“RET”) capability, which allows a mobile network operator to electronically change the pointing angle (i.e., the tilt angle) of an antenna beam generated in a vertical plane from a remote location (e.g., a control center). By electronically changing the tilt angle of the antenna beam, a mobile network operator can effectively change the size of a cell.

The tilt angle of the antenna beam generated by the linear array may be changed by applying a phase gradient or otherwise a phase taper to the RF sub-components fed to the radiating element of the array. Such a phase gradient, or otherwise a phase taper, may be achieved by a phase shifter located on a radio frequency transmission path that is between the RF port and the radiating elements of the array.

Many different types of phase shifters are known in the art, including rotary wiper arm phase shifters, trombone style phase shifters, and sliding dielectric phase shifters. In a rotary wiper arm phase shifter, the wiper feed printed circuit board is mounted on the main feed printed circuit board via a pivot pin such that the wiper feed printed circuit board is rotatable with respect to the main feed printed circuit board. Typically, the phase shifter includes one or more power dividers that divide the RF signals input to the phase shifter into a plurality of sub-components. At least a portion of the RF signal is transmitted onto the wiper feed printed circuit board and then coupled from the wiper feed printed circuit board to a transmission path of the main feed printed circuit board. The path length for each sub-component of the RF signal that is coupled from the wiper feed printed circuit board back to the main feed printed circuit board depends on the location of the wiper feed printed circuit board relative to the main feed printed circuit board. Thus, by moving the wiper feed printed circuit board (e.g., using an actuator), the phase of the sub-components of the RF signal may be adjusted so as to change the downtilt angle of the antenna beam. The trombone style phase shifter operates in a similar manner, except that the movable element of the phase shifter moves linearly rather than along an arc. The sliding dielectric phase shifter has fixed transmission paths and a movable dielectric material, which can change the coverage area or length of the dielectric material along each transmission path, thereby enabling different phase shifts along different transmission paths.

In a known RF signal feed path within the base station antenna (which extends from the radio frequency port, a first cable, a phase shifter, a second cable, a feeder panel, to the radiating element), there are typically many soldering sites to achieve electrical connections between the individual discrete components. However, too many soldering sites may adversely affect the antenna gain. Still further, the manufacturing of the soldering site is a labor-intensive operation, so excessive soldering sites may increase manufacturing costs and process difficulties. In addition, poor soldering sites are an important source of passive intermodulation (PIM) distortion, so too many soldering sites may also affect the PIM performance of the antenna.

### SUMMARY

One of the purposes of the present invention is to provide an antenna assembly and a base station antenna suitable for a communication system, whereby at least some of the defects existing in the prior art can be overcome.

According to a first aspect of the present disclosure, an antenna assembly is provided, comprising: a plurality of dual-polarization radiating elements, each dual-polarization radiating element comprising a dipole radiator pair and a feed stalk for mounting the dipole radiator pair, wherein each dual-polarization radiating element is operable within a first operating frequency band, a feeder panel for feeding each dual-polarization radiating element, the feeder panel including a power divider, wherein the respective feed stalks and the feeder panel form an integrated feed printed circuit board.

According to a second aspect of the present disclosure, an antenna assembly is provided, comprising: a first dual-polarization radiating element that comprises a first dipole radiator and a second dipole radiator; a second dual-polarization radiating element that comprises a third dipole radiator and a fourth dipole radiator; and a monolithic printed circuit board that comprises a first feed stalk, a second feed stalk and a feeder panel, wherein the feeder panel includes a first power divider having a first output that is coupled to the first dipole radiator and a second output that is coupled to the second dipole radiator, and a second power divider having a first output that is coupled to the third dipole radiator and a second output that is coupled to the fourth dipole radiator, wherein the first and second dipole radiators are mounted on the first feed stalk and the third and fourth dipole radiators are mounted on the second feed stalk.

According to a third aspect of the present disclosure, a base station antenna is provided, comprising: a reflecting plate; a phase shifter mounted behind the reflecting plate; a plurality of antenna assemblies mounted on the reflecting plate, each antenna assembly configured to an antenna assembly according to some examples of the present application, wherein an electrical feed signal is transmitted between each antenna assembly and the phase shifter by means of a respective phase cable.

According to a fourth aspect of the present disclosure, a base station antenna is provided, comprising: a reflecting plate, a phase shifter mounted on the rear side of the reflecting plate, a plurality of antenna assemblies mounted on a reflecting plate, each antenna assembly configured to be an antenna assembly according to some examples of the present application.

### BRIEF DESCRIPTION OF THE DRAWING

FIG. 1 is a schematic perspective diagram of a base station antenna according to some examples of the present application.

FIG. 2 is a schematic block diagram of a base station antenna according to some examples of the present application.

FIG. 3 is a schematic perspective diagram of an antenna assembly.

FIG. 4 is a schematic circuit diagram of a plurality of antenna assemblies and phase shifters, according to some examples of the present application.

FIG. 5 is a schematic perspective diagram of the antenna assembly of FIG. 4.

FIG. 6 is a schematic side-view of the antenna assembly of FIG. 5.

FIGS. 7 and 8 are side-views of an antenna assembly with line crossings present on a feeder panel of a printed circuit board according to some further examples of the present application.

FIGS. 9 and 10 show are schematic views showing how an antenna assembly according to examples of the present application can be mounted in an antenna.

FIGS. 11 and 12 are schematic side-view diagrams of antenna assemblies according to still further examples of the present application, respectively.

FIG. 13 is a schematic perspective diagram of an antenna assembly, according to yet another example of the present application.

It should be noted that in the implementations described below, the same reference signs are sometimes used across different attached drawings to denote the same parts or parts with similar functions, and repeated descriptions thereof are omitted. In some cases, similar labels and letters are used to denote similar items. Therefore, once an item is defined in one attached drawing, there is no need for further discussion in subsequent attached drawings.

For ease of understanding, the position, dimension, and range of each structure shown in the attached drawings and the like may not indicate the actual position, dimension, and range. Therefore, the present disclosure is not limited to the position, size, range, etc. disclosed in the attached drawings.

### DETAILED DESCRIPTION

The present disclosure will be described below with reference to the attached drawings, which show several examples of the present disclosure. However, it should be understood that the present disclosure can be presented in many different ways and is not limited to the examples described below. In fact, the examples described below are intended to make the present disclosure more complete and to fully explain the protection scope of the present disclosure to those skilled in the art. It should also be understood that the examples disclosed in the present disclosure may be combined in various ways so as to provide more additional examples.

It should be understood that the terms used herein are only used to describe specific examples, and are not intended to limit the scope of the present disclosure. All terms used herein (including technical terms and scientific terms) have meanings normally understood by those skilled in the art unless otherwise defined. For the sake of brevity and/or clarity, well-known functions or structures may not be described in detail.

As used herein, when an element is said to be “on” another element, “attached” to another element, “connected” to another element, “coupled” to another element, or “in contact with” another element, etc., the element may be directly positioned on another element, attached to another element, connected to another element, coupled to another element, or in contact with another element, or an intermediate element may be present. In contrast, if an element is described as “directly” “on” another element, “directly attached” to another element, “directly connected” to another element, “directly coupled” to another element, or “directly in contact with” another element, no intermediate elements are present. As used herein, when one feature is arranged “adjacent” to another feature, it may mean that one feature has a part overlapping with the adjacent feature or a part located above or below the adjacent feature.

In this specification, elements, nodes or features that are “connected” together may be mentioned. Unless explicitly stated otherwise, “connected” means that one element/node/feature can be mechanically, electrically, logically or otherwise connected with another element/node/feature in a direct or indirect manner to allow interaction, even though the two features may not be directly connected. That is, “connected” means direct and indirect connection of components or other features, including connection using one or more intermediate components.

As used herein, spatial relationship terms such as “upper”, “lower”, “left”, “right”, “front”, “back”, “high” and “low” can explain the relationship between one feature and another in the drawings. It should be understood that spatial relational terms, in addition to the orientations shown in the attached drawings, also encompass different orientations of the apparatus during use or operation. For example, when the apparatus is flipped in the attached drawings, a feature previously described as “below” another feature may now be described as “above” that other feature. The apparatus may also be oriented in other ways (rotated 90 degrees or in other orientations), and the relative spatial relationships will be interpreted accordingly in those cases.

As used herein, the term “A or B” comprises “A and B” and “A or B”, not exclusively “A” or “B”, unless otherwise specified.

As used herein, the term “exemplary” means “serving as an example, instance, or illustration”, rather than as a “model” to be precisely replicated. Any realization method described exemplarily herein may not be necessarily interpreted as being preferable or advantageous over other realization methods. Furthermore, the present disclosure is not limited by any expressed or implied theory given in the above technical field, background art, summary of the invention or specific embodiments.

As used herein, the word “basically” means including any minor changes caused by design or manufacturing defects, device or component tolerances, environmental influences, and/or other factors. The term “essentially” also allows for the divergence from the perfect or ideal situation due to parasitic effects, noise, and other practical considerations that may be present in the actual implementation.

In addition, for reference purposes only, “first,” “second,” and similar terms may also be used herein, and thus are not intended to be limiting. For example, unless explicitly stated in context, the use of words such as “first,” “second,” or other such numerical terms concerning structures or components does not imply any particular order or sequence.

It should also be understood that when the term “comprising/including” is used herein, it indicates the presence of the specified features, steps, operations, units, and/or components but does not exclude the presence or addition of one or more other features, steps, operations, units, and/or components, and/or combinations thereof.

The base station antenna 100 according to some examples of the present disclosure will now be described in more detail with reference to the attached drawings. It should be noted that the base station antenna 100 may also have other components, and in order to avoid obscuring the main points of the present disclosure, the other components are not shown in the attached drawings and will not be discussed herein. It should also be noted that the drawings only schematically show the relative positional relationship of various components, and there is no particular limitation on the specific structure of each component.

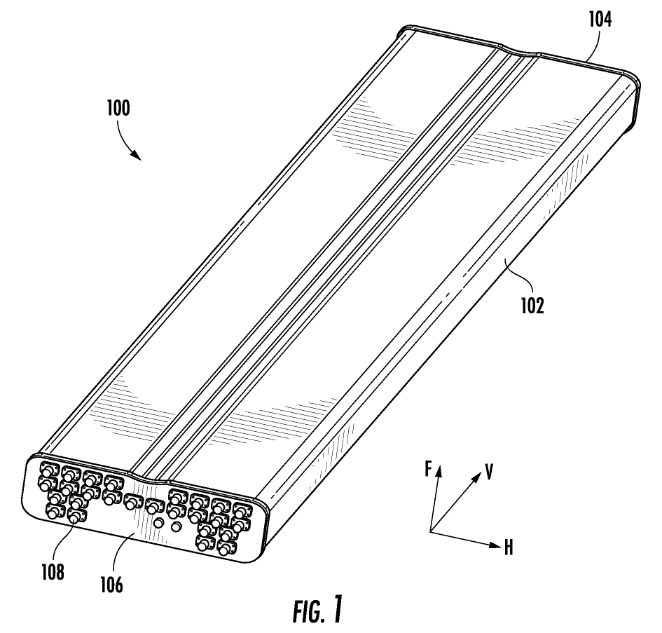

FIG. 1 is a schematic perspective view of a base station antenna 100. As shown in FIG. 1, the base station antenna 100 is tubular with a generally rectangular cross-section. The base station antenna 100 includes a radome 102, a top end cap 104, and a bottom end cap 106. A plurality of radio frequency ports 108 are installed in the form of radio frequency connectors on the bottom end cap 106. The radio frequency ports 108 pass through the bottom end cap 106 for electrically connecting the base station antenna 100 with an external radio device (not shown). The radome 102, the top end cap 104, and the bottom end cap 106 may form an exterior housing of the antenna 100.

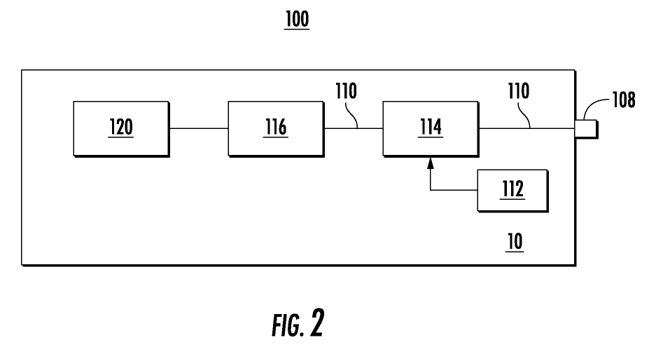

FIG. 2 shows a schematic view of a base station antenna 100. As shown in FIG. 2, the base station antenna 100 includes a radio frequency port 108, a cable 110, a remote electronic tilt (RET) unit 112, a phase shifter 114, a feeder panel 116, and a radiating element array 120, among others. Additionally, the base station antenna 100 may include a reflecting plate 10, the reflecting plate 10 may include a metallic primary surface, and the metallic primary surface provides a ground plane for the radiating element array 120 and reflects electromagnetic radiation directed backwardly by the radiating elements back to a forward direction. Generally, each of the radiating elements of the array of radiating elements 120 may be configured as a dual-polarization radiating element.

Each dual-polarization radiating element of the radiating element array 120 may be mounted to extend forwardly (i.e. in the forward direction F) from the reflecting plate 10. Each radiating element linear array may include a plurality of radiating elements arranged along the longitudinal direction V of the antenna 100. The longitudinal direction V may be a direction of a longitudinal axis of the antenna or may be parallel to the longitudinal axis. The longitudinal direction V is perpendicular to the transverse direction H (or alternatively the horizontal direction) and the forward direction F. As used herein, the term “vertical” does not necessarily require the object to be fully vertical (e.g., the antenna may have a small mechanical downtilt).

Each linear array may be connected to two ports of an external radio device (one port for each polarization). Each radio frequency port 108 of the antenna 100 may be configured to receive an RF signal from a respective port of the radio device (e.g., a first polarized RF signal) and transmit via the cable 110 to the phase shifter 114. The phase shifter 114 may be configured to receive the RF signal and divide it into a plurality of sub-components, each of which may be fed to a first polarized radiator of a respective subset of linear arrays (typically, each sub-component is fed to one to four radiating elements). The various sub-components of the RF signal may be transmitted by each of the first polarized radiators of the linear array, thereby creating a first polarized antenna beam covering a generally fixed coverage area (e.g., a 120° sector of a cell). Typically, these linear arrays have a remote electronic tilt (“RET”) function (implemented by the RET unit) that allows a cellular network operator to electronically change the pointing angle of the generated antenna beam in the pitch plane (i.e., the downtilt angle of the antenna beam) from a remote location (e.g., the control center). By electronically changing the downtilt angle of the antenna beam, the cellular network operator can effectively change the sector size of the antenna service because the downtilt angle determines the distance at which the antenna beam extends from the base station.

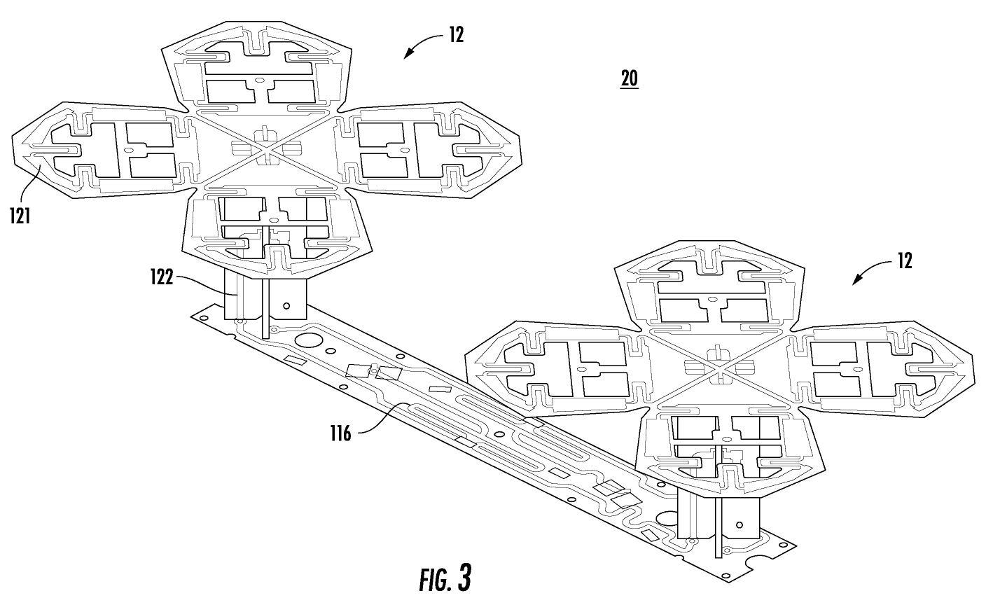

FIG. 3 shows a schematic perspective diagram of an antenna assembly 20. As shown in FIG. 3, the antenna assembly 20 may include a plurality (two in the FIG.) of dual-polarization radiating elements 12, each of which may include a dipole radiator pair 121 and a cross-feed stalk pair 122 for mounting the dipole pair 121. Further, each antenna assembly 20 may include a feeder panel 116 that is substantially parallel to the main surface of the reflecting plate 10. The cross-feed stalk printed circuit board 122 of the dual-polarization radiating element 12 may be mounted substantially perpendicular to the feeder panel 116 and electrically coupled with the feed circuit on the feeder panel 116 by way of a soldering operation thereby enabling transmission of the feed signal (i.e., sub-component of the RF signal). However, too many soldering sites may adversely affect the antenna gain. Still further, the manufacturing of the soldering site is a labor-intensive operation, so excessive soldering sites may increase manufacturing costs and process difficulties. In addition, poor soldering sites are an important source of PIM distortion, so too many soldering sites may also affect the PIM performance of the antenna.

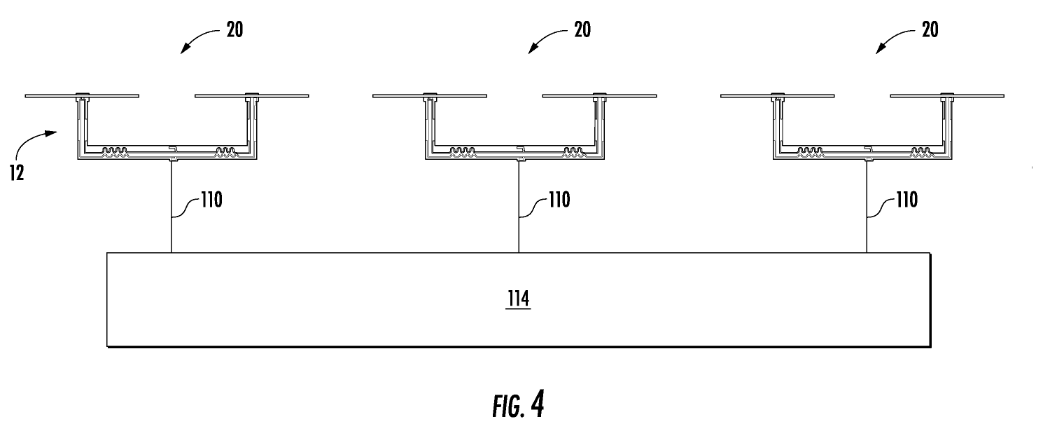

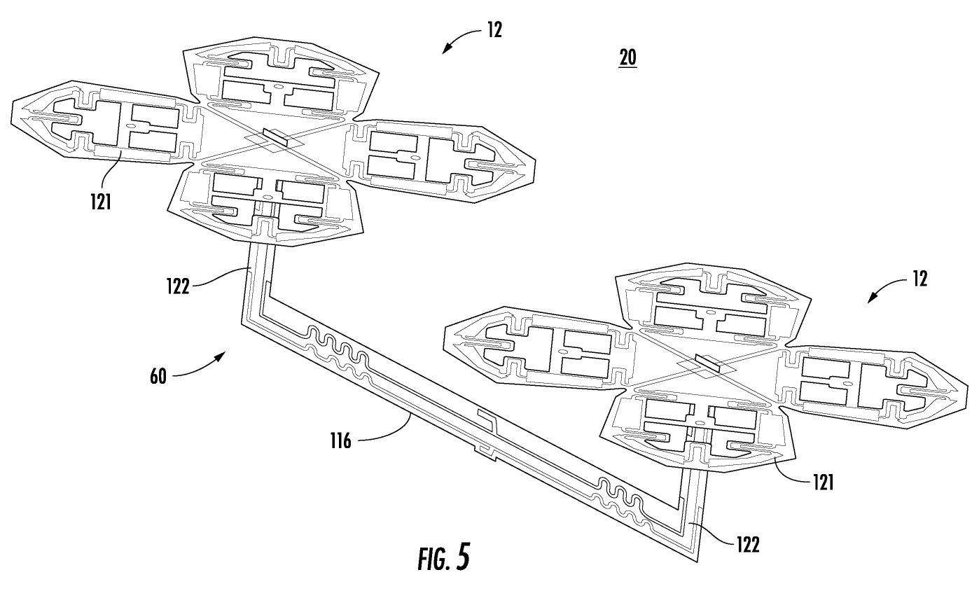

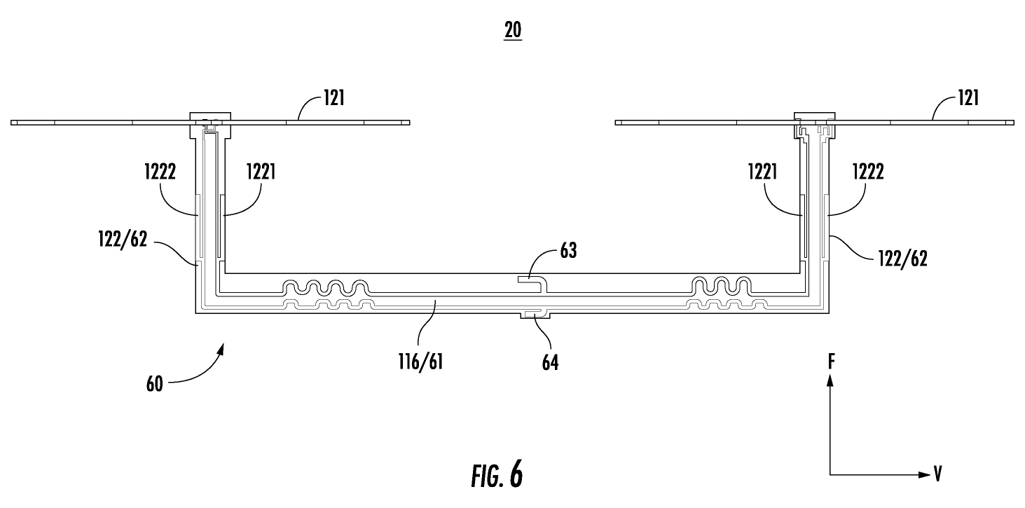

Referring to FIGS. 4-6, FIG. 4 shows a schematic circuit diagram of a plurality of antenna assemblies 20 and a phase shifter 114; FIG. 5 is a schematic perspective diagram of an antenna assembly 20 of some examples of the present application; and FIG. 6 is a schematic side-view diagram of the antenna assembly 20 of FIG. 5.

As shown in FIG. 4, a plurality (three in the FIG.) of antenna assemblies 20 can be arranged along the longitudinal direction V of the antenna at a distance from one another such that a plurality of dual-polarization radiating elements 12 on the plurality of antenna assemblies 20 can be arranged into a linear array extending along the longitudinal direction V. An electrical feed signal may be transmitted between each antenna assembly 20 and the phase shifter 114 by way of cables 110 having a low insertion loss. It will be understood that the number of dual-polarization radiating elements 12 on the different antenna assemblies 20 may be the same or may be different. In some examples, at least a portion of the antenna assembly 20 may include two, three, or four, etc., of the dual-polarization radiating elements 12. In some examples, at least a portion of the antenna assembly 20 may also be a dual-polarization radiating element 12, where, for example, the power divider on the feeder panel 116 may be omitted.

As shown in FIG. 5, the antenna assembly 20 may include two dual-polarization radiating elements 12, each of which may include a dipole radiator pair 121 and a feed stalk 122 for mounting the dipole radiator pair 121. The feed stalk 122 of some examples of the present application may constitute a single feed stalk, distinct from the cross feed stalk 122 of FIG. 3, on which the feed stalk 122 may be integrated with a feeding balun structure for dual-polarization feed. Further, the antenna assembly 20 may include a feeder panel 116 for feeding the various dual-polarization radiating elements 12, which may constitute a feed printed circuit board 60 integral with the various single feed stalks 122. That is, the feeder panel 116 may constitute a first component of a feed printed circuit board 60, while the various single feed stalks 122 may constitute other components of that feed printed circuit board 60. Each single feed stalk 122 may extend forwardly from the feeder panel 116 and may mechanically and electrically connect with a respective dipole radiator pair 121. A highly integrated and compact antenna assembly 20 is thus achieved.

Referring to FIG. 6, a first metal line 61 related to a power divider may be provided on the feeder panel 116 of the feed printed circuit board 60, and a second metal line 62 related to a feeding balun may be provided on a respective feed stalk 122 of the feed printed circuit board 60, respectively. The first metal line 61 of the feeder panel 116 may also include bonding pads 63, 64 (each polarizing one bonding pad, the bonding pad may alternatively be disposed on the back side of the feeder panel 116) for soldering with the cable 110 from the phase shifter 114. The power divider of the feeder panel 116 may be configured to electrically connect with the bonding pads 63, 64, divide the feed signal from the phase shifter 114 (i.e., the sub-component of the RF signal) into a plurality of sub-feed signals, and feed the sub-feed signals to the respective dipole radiators via the feeding baluns.

In some examples, the feed printed circuit board 60 may constitute a single-layer printed circuit board or a multi-layer printed circuit board. The feeding printed circuit board 60 may comprise at least one dielectric substrate printed on at least one printed surface of the dielectric substrate with a first metal line 61 and a second metal line 62. That is, the first and second metal lines 61, 62 may be printed on one printed surface of one dielectric substrate or may be distributedly printed on a plurality of printed surfaces of one or more dielectric substrates and electrically connected with one another by way of a conductive structure, such as a metalized through hole.

In examples not shown, each antenna assembly 20 may include two integrated feed printed circuit boards 60, each integrated feed printed circuit board 60 may include a feeder panel 116 responsible for one polarized feed and various feed stalks 122. Advantageously, the two integrated feed printed circuit boards 60 may be snapped together with each other and isolated from each other via an isolation layer (e.g., a metal layer). Each dual-polarization radiating element 12 may include, for example, a dipole radiator pair 121 and a parallel feed stalk 122 pair for mounting the dipole radiator pair 121, where each feed stalk 122 pair is responsible for a polarized feed. Further, each antenna assembly 20 may include, for example, parallel feeder panel 116 pairs for feeding the various dual-polarization radiating elements 12, wherein each feeder panel 116 in the parallel feeder panel pair is responsible for a polarized feed.

With continued reference to FIG. 6, each feed stalk 122 may include: A first feeding balun 1221, for feeding a first dipole radiator of a respective dipole radiator pair 121; a second feeding balun 1222, for feeding a second dipole radiator of a respective dipole radiator pair 121. The first and second feeding baluns 1221 and 1222 may include feed lines and reference grounds, respectively, and each feed line and reference ground may be printed on at least one printed surface of the feed stalk 122. That is, in some examples, the respective feed lines and reference grounds of the first and second feeding baluns 1221, 1222 may be printed on the same printed surface. In some examples, the respective feed lines and reference grounds of the first and second feeding baluns 1221, 1222 may be printed in a distributional manner on two or more printed surfaces. It will be understood that the feeding balun structures 1221 and 1222 of feed stalk 122 may have a variety of configurations and that the illustrated examples of this application are merely exemplary and schematic embodiments and should not be understood in a limited manner. With respect to the feed stalk 122, the feeding balun structures 1221, 1222 can be referenced in reference to the publication WO2024/011344A1, the disclosure of which can be incorporated by reference into this application.

In some examples, the antenna assembly 20 may include two adjacent dual-polarization radiating elements 12, i.e., a first dual-polarization radiating element 12 and a second dual-polarization radiating element 12. The respective feeding baluns 1221, 1222 on the feed stalk 122 of the two adjacent dual-polarization radiating elements 12 may be arranged in reverse. As shown in FIG. 6, viewing along the longitudinal direction V, the order of the first and second feeding baluns 1221, 1222 on the first feed stalk 122 is reversed from the order of the first and second feeding baluns 1221, 1222 on the second feed stalk 122. As such, the two first feeding balun 1221 feed lines may be inboard of each other of the two feed stalks 122 and the two second feeding balun 1222 feed lines may be outboard of each other of the two feed stalks 122. This reverse arrangement is advantageous because the first metal line 61 of the feeder panel 116 may be connected to the respective feed lines of the feeding baluns 1221, 1222 without line-crossing, thereby making the wiring on the feeder panel 116 simpler. In order to provide for a proper feed electrical connection between the radiator pair 121 and the feeding baluns 1221 and 1222 of feed stalk 122, the soldering locations between the feeding baluns 1221 and 1222 of feed stalk 122 and the radiator pair 121 may be adapted to a reverse arrangement of the feeding baluns 1221 and 1222 on the feed stalk 122. An example arrangement for the soldering site may refer to the publication WO2024/011344A1, the disclosure of which may be incorporated into this application by reference.

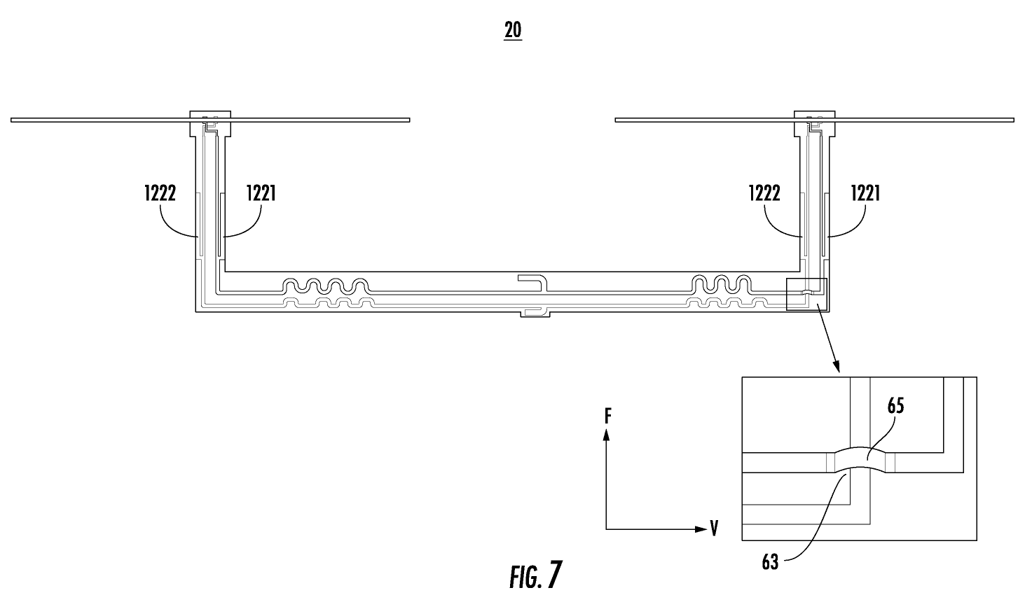

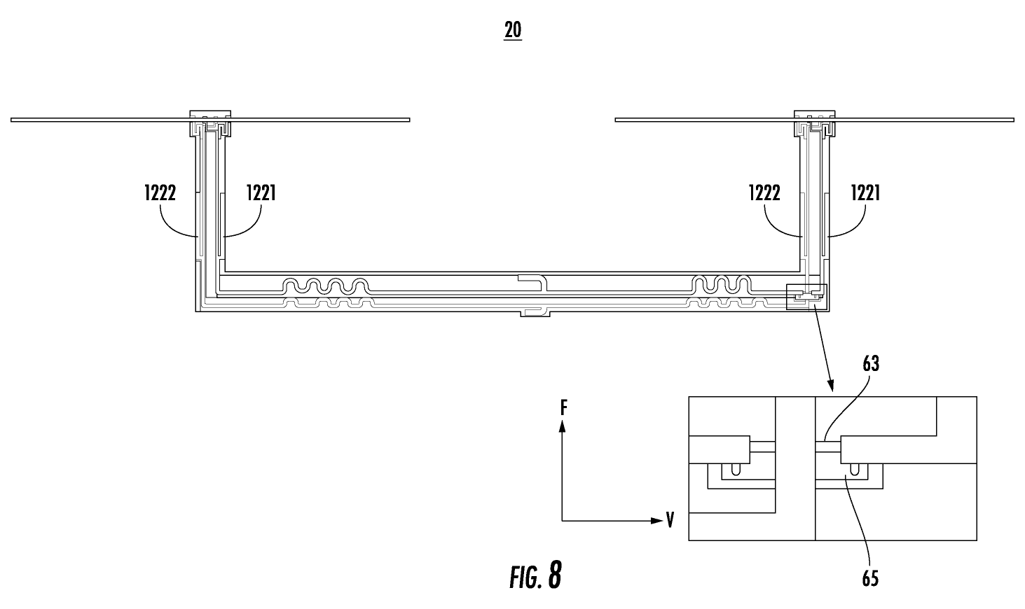

In some examples, the antenna assembly 20 may include two adjacent dual-polarization radiating elements 12, i.e., a first dual-polarization radiating element and a second dual-polarization radiating element. The respective feeding baluns 1221, 1222 on feed stalk 122 of the two adjacent dual-polarization radiating elements 12 may be arranged in the same direction. As shown in FIGS. 7 and 8, viewing along the longitudinal direction V, the order of the first and second feeding baluns 1221, 1222 on first feed stalk 122 is the same as the order of the first and second feeding baluns 1221, 1222 on second feed stalk 122. As such, the feed lines of both the first feed balun 1221 of first feed stalk 122 and the second feed balun 1222 of second feed stalk 122 may be inboard towards each other of the two feed stalks 122, while the feed lines of both the second feed balun 1222 of first feed stalk 122 and the first feed balun 1221 of second feed stalk 122 may be outboard backwards each other of the two feed stalks 122. Such a co-directional arrangement may simplify the manufacture of the antenna assembly 20 because the various dual-polarization radiating elements 12 of the antenna assembly 20 may be configured identically to one another without having to manufacture feed stalks 122 having different feed balun arrangements and/or radiator pairs having different bonding pad arrangements.

However, such a co-directional arrangement may cause the lines of the first metal line 61 on the feeder panel 116 to intersect. As shown in FIGS. 7 and 8, the first portion of the first metal line 61 is connected to the feed line of first feed balun 1221 on the first feed stalk 122 without line-crossing, and the second portion is connected to the feed line of first feed balun 1221 of second feed stalk 122 with line-crossing; the second portion of the first metal line 61 is connected to the feed line of second feed balun 1222 of first feed stalk 122 without line-crossing, and the second portion is connected to the feed line of second feed balun 1222 of second feed stalk 122 with line-crossing. The line-crossing may be a line-crossing of the first portion of the first metal line 61 with the second portion of the first metal line 61.

In order to achieve smooth transmission between lines in the case of line-crossing, the first portion of the first metal line 61 may include an interrupted window 63 over which the second portion of the first metal line 61 extends. Further, the antenna assembly 20 may further comprise a bridge 65 that may be configured to communicate with the first portion of the first metal line 61 across the interrupted window 63 so as to form a transition for line-crossing. As shown in FIG. 7, the bridge 65 may be formed as an arcuate metal bridge 65. As shown in FIG. 8, the bridge 65 may constitute a printed bridge circuit formed by a metalized bore and a backside line.

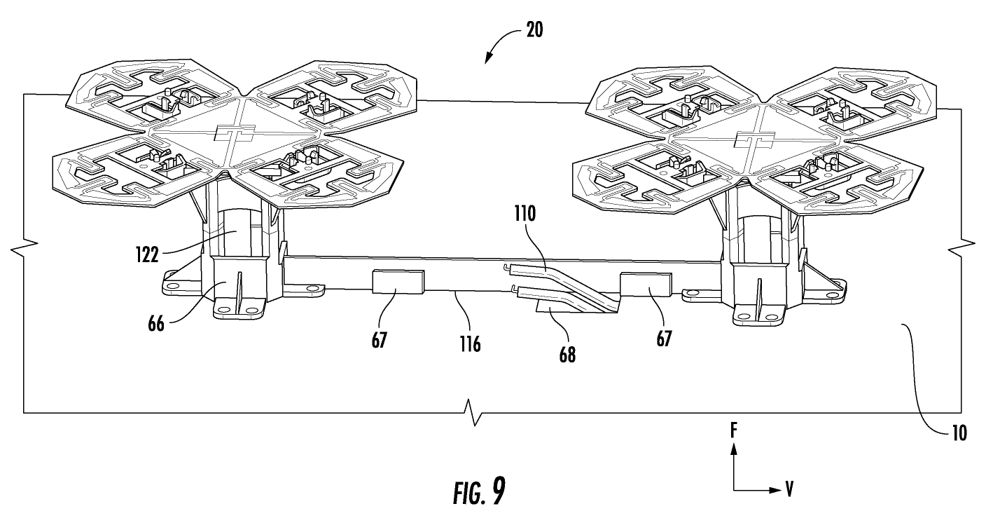

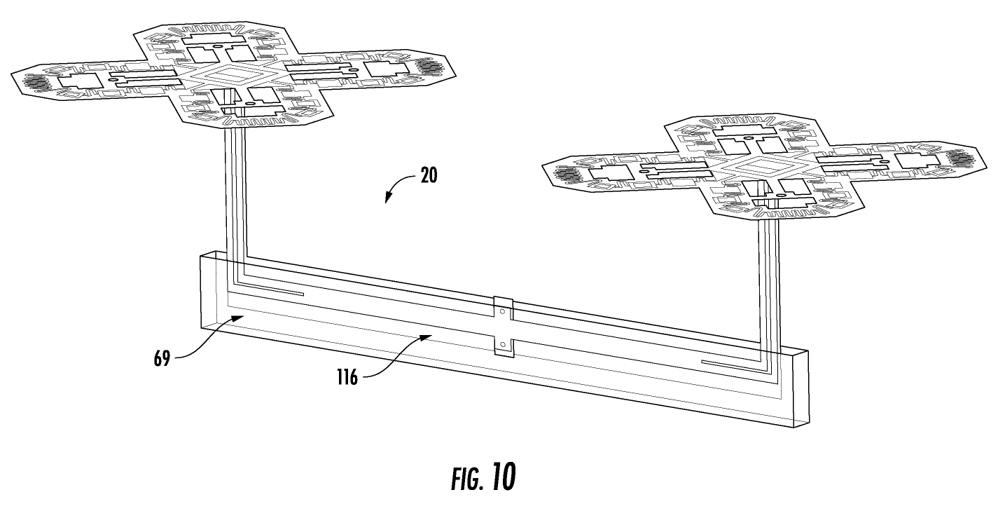

FIGS. 9 and 10 illustrate how antenna assemblies 20 according to examples of the present application may be mounted in a base station antenna. The antenna assembly 20 may be mounted on a main surface of the reflecting plate 10. In the state in which the antenna assembly 20 is assembled to completion, the feed printed circuit board 60 of the antenna assembly 20 (feeder panel 116 and various feeding rods 122) may be substantially perpendicular to the main surface of the reflecting plate 10. The feed printed circuit board 60, or the feeder panel 116 thereof, of the antenna assembly 20 may extend substantially along the longitudinal direction V of the antenna, and the feed stalks 122 thereof may extend further forward along the forward direction F from the feeder panel 116.

In the example shown in FIG. 9, in order to mount the antenna assembly 20, one or more of the clamp connections 67 may be mounted or shaped on the reflecting plate 10 and the feed printed circuit board 60 or the feeder panel 116 thereof may be clamped on the clamp connection 67. The respective clamp connection 67 may be formed by a protruding wall extending forwardly from the reflecting plate 10. Additionally, to further stabilize the radiating element, a support structure 66 may be provided for the radiating element.

In the example shown in FIG. 10, in order to mount the antenna assembly 20, a cavity structure 69 may be mounted or shaped on the reflecting plate 10, within which the feed printed circuit board 60 or the feeder panel 116 of the antenna assembly 20 may be mounted. The cavity structure 69 may include a cavity extending longitudinally along the antenna within which a metal line of the feed printed circuit board 60 of the antenna assembly 20, such as at least a portion of the first metal line 61 of the feeder panel 116, may be accommodated. Because the cavity structure 69 is in ground connection with the reflecting plate 10, the cavity structure 69 may serve as a reference such that the metal line within it becomes a stripline, whereby the cavity structure 69 may advantageously reduce insertion loss of the feed printed circuit board 60. This improves antenna gain characteristics.

To provide for an electrical connection between the antenna assembly 20 and the phase shifter 114 behind the reflecting plate 10, a channel 68 may be provided on the reflecting plate 10, from which the respective cables 110 may exit from phase shifter 114 through the channel 68 and extend to the electrical feeder panel 116 of the antenna assembly 20 for electrical connection with the electrical feeder panel 116.

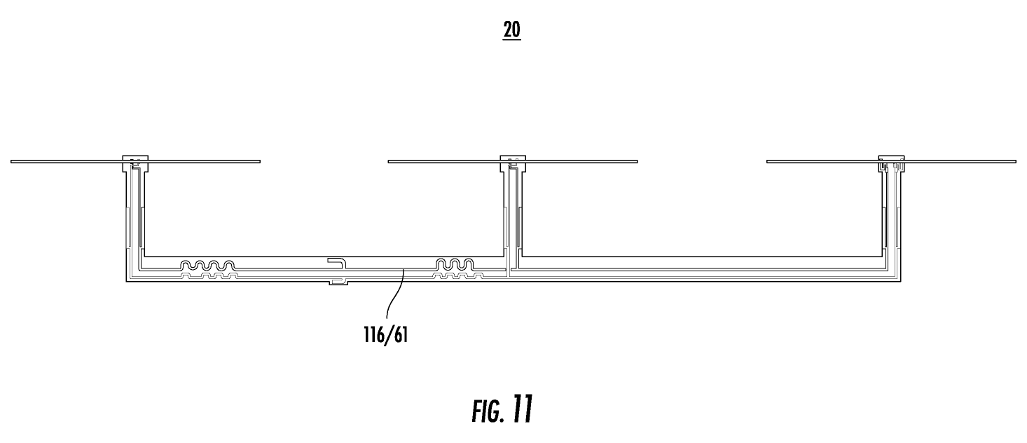

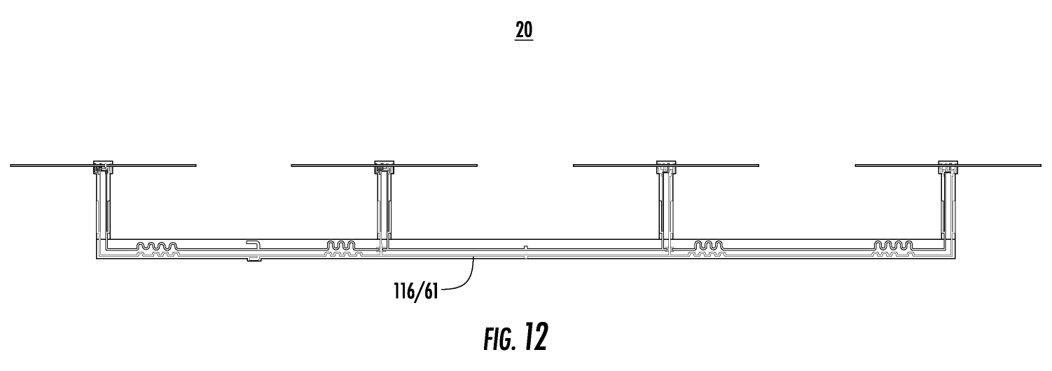

FIGS. 11 and 12 are schematic side-views of antenna assemblies 20 according to still further examples of the present application. As shown in FIG. 11, the antenna assembly 20 may include three dual-polarization radiating elements 12 and a feeder panel 116. As shown in FIG. 12, the antenna assembly 20 may include four dual-polarization radiating elements 12 and a feeder panel 116. In some examples, the antenna assembly 20 may include a first and a second pair of dual-polarization radiating elements, each pair of dual-polarization radiating elements may involve two adjacent dual-polarization radiating elements 12. The respective feed baluns 1221, 1222 on the feed stalk 122 of the first dual-polarization radiating element 12 pair may be arranged in the same direction, while the respective feed baluns 1221, 1222 on the feed stalk 122 of the second dual-polarization radiating element 12 pair may be arranged in reverse directions.

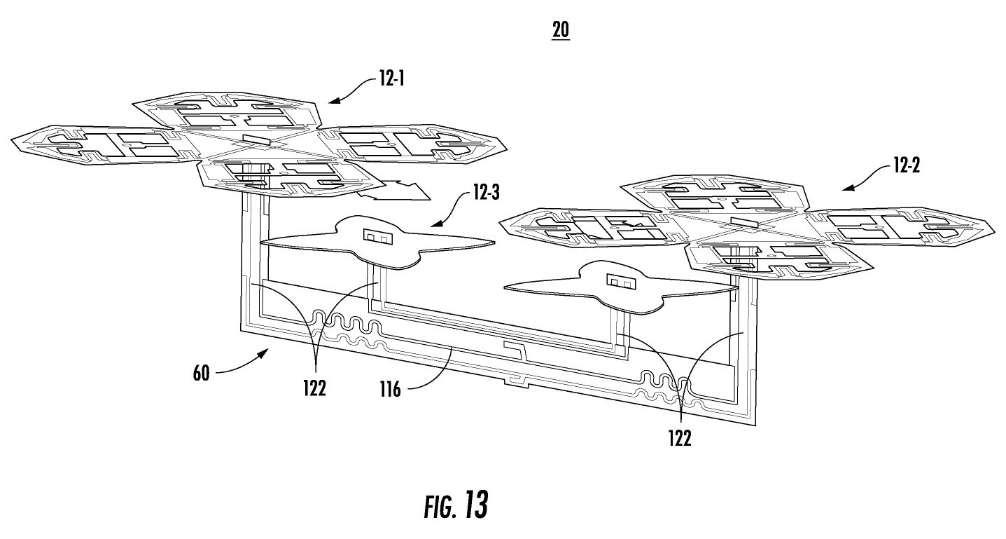

Referring to FIG. 13, a schematic perspective view of an antenna assembly 20 is shown, according to further examples of the present application. The antenna assembly 20 may be constructed as a multi-frequency band antenna assembly, which may include: a low frequency band radiating element, the operating frequency band of which may be, for example, 617-960 MHz or a sub-band thereof; an intermediate frequency band radiating element, which may be, for example, 1427-2690MHz or a sub-band thereof; and/or a high frequency band radiating element, which may be, for example, 3-5GHz or a sub-band thereof. As shown in FIG. 13, the multi-frequency band antenna assembly 20 may include a first dual-polarization radiating element 12-1 and a second dual-polarization radiating element 12-2 operable within a first operating frequency band (e.g., 617-960MHz or a sub-band thereof). Further, the multi-frequency band antenna assembly 20 may include at least one, such as two third dual-polarization radiating elements 12-3, capable of operating within a second operational frequency band (e.g., 1427-2690MHz or a sub-band thereof) that is higher than the first operational frequency band. Each of the third dual-polarization radiating elements 12-3 may include a dipole radiator pair 121 and a feed stalk 122 for mounting the dipole radiator pair 121. The feed stalk 122 of the various dual-polarization radiating elements 12 may be formed as an integral feed printed circuit board 60 with one feeder panel 116. Advantageously, at least one third dual-polarization radiating element 12-3 may be provided between adjacent first and second dual-polarization radiating elements 12-1, 12-2. A compact multi-frequency band antenna assembly 20 is thus achieved.

Although some specific examples of the present disclosure have been described in detail by specific examples, those skilled in the art should understand that the above embodiments are only for illustration, not for limiting the scope of the present disclosure. The examples disclosed herein can be combined arbitrarily without departing from the spirit and scope of the present disclosure. Those skilled in the art should also understand that various modifications can be made to the examples without departing from the scope and spirit of the present disclosure. The scope of the present disclosure is defined by the Claims attached.

What is claimed is:

1. An antenna assembly, which comprises:
a plurality of dual-polarization radiating elements, each dual-polarization radiating element comprising a dipole radiator pair and a feed stalk for mounting the dipole radiator pair, wherein each dual-polarization radiating element is operable within a first operating frequency band,
a feeder panel for feeding each dual-polarization radiating element, the feeder panel including a power divider,
wherein the respective feed stalks and the feeder panel form an integrated feed printed circuit board.

2. The antenna assembly of claim 1, wherein the power divider is part of first metal lines, and second metal lines are provided on the respective feed stalks of the feed printed circuit board.

3. The antenna assembly of claim 2, wherein the feed printed circuit board includes at least one dielectric substrate and the first metal line and the second metal lines are printed on at least one surface of the at least one dielectric substrate, wherein the normal direction of the printed surface of the dielectric substrate is substantially parallel to the horizontal direction of the antenna.

4. The antenna assembly of claim 2, wherein the feed printed circuit board extends along a longitudinal direction of the antenna.

5. The antenna assembly of claim 4, wherein each feed stalk of the feed printed circuit board extends forwardly from the feeder panel and mechanically and electrically connects with a respective dipole radiator pair.

6. The antenna assembly of claim 2, wherein each feed stalk comprises:
a first feed balun for feeding a first dipole radiator of a respective dipole radiator pair, the first feed balun being part of a first of the second metal lines,a second feed balun for feeding a second dipole radiator of a respective dipole radiator pair, the second feed balun being part of a second of the second metal lines,wherein the first and second feed baluns include a feed line and a reference ground,
respectively, and each feed line and reference ground is printed on at least one printed surface.

7. (canceled)

8. The antenna assembly of claim 6, wherein the plurality of dual polarization radiating elements comprise a first dual-polarization radiating element and a second dual-polarization radiating element that is adjacent the first dual-polarization radiating element, wherein the first and second feed baluns on the first feed stalk are arranged in reverse with respect to the first and second feed baluns on the second feed stalk such that the two first feed balun's feed lines are inboard facing each feed stalk, while the two second feed balun's feed lines are outboard away from the feed stalks.

9. The antenna assembly of claim 8, wherein a first portion of the first metal line is connected to two first feed baluns' feed lines without line-crossing, and a second portion of the first metal line is connected to two second feed baluns' feed lines without line-crossing.

10. The antenna assembly of claim 6, wherein the plurality of dual polarization radiating elements comprise a first dual-polarization radiating element and a second dual-polarization radiating element that is adjacent the first dual-polarization radiating element, wherein the first and second feed baluns on the first feed stalk of the first dual-polarization radiating element are arranged in the same direction with respect to the first and second feed baluns on the second feed stalk of the second dual-polarization radiating element such that the feed line of first feed balun of first feed stalk and the feed line of second feed balun of second feed stalk are inboard facing each feed stalk, while the feed line of second feed balun of first feed stalk and the feed line of first feed balun of second feed stalk are outboard away from the feed stalks.

11. The antenna assembly according to claim 4, wherein,
a first portion of the first metal line connected on first side to the feed line of first feed balun on a first feed stalk without line-crossing, and connected on second side to the feed line of first feed balun on a second feed stalk with line-crossing,
a second portion of a first metal line connected on first side to the feed line of second feed balun on a first feed stalk without line-crossing, and connected on second side to the feed line of second feed balun on a second feed stalk with line-crossing,
wherein the line crossing is on a second side, involving the first portion of first metal line and second portion of first metal line.

12-15. (canceled)

16. A base station antenna, comprising:
a reflecting plate,
a phase shifter mounted on the rear side of the reflecting plate,
a plurality of antenna assemblies mounted on a reflecting plate, each antenna assembly configured to be an antenna assembly according to claim 1, wherein an electrical feed signal is transmitted between each antenna assembly and the phase shifter by way of a respective phase cable.

17. The base station antenna of claim 16, wherein the feed printed circuit board of each antenna assembly is substantially perpendicular to the main surface of the reflecting plate.

18-19. (canceled)

20. The base station antenna of claim 16, wherein a channel is provided on the reflecting plate and a phase cable extends from the phase shifter through the channel to the feeder panel of the antenna assembly for electrical connection to the electrical feed.

21-24. (canceled)

25. An antenna assembly, comprising:
a first dual-polarization radiating element that comprises a first dipole radiator and a second dipole radiator;
a second dual-polarization radiating element that comprises a third dipole radiator and a fourth dipole radiator; and
a monolithic printed circuit board that comprises a first feed stalk, a second feed stalk and a feeder panel,
wherein the feeder panel includes a first power divider having a first output that is coupled to the first dipole radiator and a second output that is coupled to the second dipole radiator, and a second power divider having a first output that is coupled to the third dipole radiator and a second output that is coupled to the fourth dipole radiator,
wherein the first and second dipole radiators are mounted on the first feed stalk and the third and fourth dipole radiators are mounted on the second feed stalk.

26. The antenna assembly of claim 25, wherein the first feed stalk includes a first feed balun that is coupled to a first output of the first power divider and a second feed balun that is coupled to a first output of the second power divider, and the second feed stalk includes a third feed balun that is coupled to a second output of the first power divider and a fourth feed balun that is coupled to a second output of the second power divider.

27. The antenna assembly of claim 26, wherein the first feed stalk has an inner side that faces the second feed stalk, and the second feed stalk has an inner side that faces the first feed stalk, wherein the first feed balun is on the inner side of the first feed stalk and the third feed balun is on the inner side of the second feed stalk.

28. A base station antenna, comprising:
a reflecting plate,
a phase shifter mounted on the rear side of the reflecting plate,
a plurality of antenna assemblies mounted on a reflecting plate, each antenna assembly configured to be an antenna assembly according to claim 25.

29. The base station antenna of claim 28, wherein the feed printed circuit board of each antenna assembly is substantially perpendicular to the main surface of the reflecting plate.

30. (canceled)

31. The base station antenna of claim 29, wherein at least part of the feeder panel is mounted in a cavity structure that includes a cavity extending longitudinally along the antenna.

32. The base station antenna of claim 31, wherein the cavity structure is grounded to the reflecting plate such that at least a portion of a first metal line within the cavity structure comprises a stripline transmission line.
